(19) United States
(12) Patent Application Publication
(10) Pub. No.: US 2013/0050743 A1
(43) Pub. Date: Feb. 28, 2013

(54) System and Method of Print Job Retrieval from the Cloud

(71) Applicants: Forrest Lane Steely, Lexington, KY (US); Joel Young, Orlando, FL (US)

(72) Inventors: Forrest Lane Steely, Lexington, KY (US); Joel Young, Orlando, FL (US)

(21) Appl. No.: 13/221,949

(22) Filed: Aug. 31, 2011

(51) Int. Cl. G06K 15/02

(52) U.S. Cl. 358/1.15

(57) ABSTRACT

A method for print job retrieval from the cloud includes sending one or more files to a storage location, receiving the storage location identifier where the one or more files is stored, encoding the storage location identifier into a barcode, scanning the barcode, decoding the barcode to obtain the storage location identifier, retrieving the one or more files from the storage location and processing the one or more files.

### CROSS REFERENCE TO RELATED APPLICATION

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Technical Field

The present disclosure relates to printing, and, more particularly, to print job retrieval from the cloud.

2. Description of the Related Art

There is an ongoing trend in many organizations to shift towards mobile computing as a means for conducting several core business processes using computing devices. Today, many mobile devices are designed with faster and more powerful processors which enable users to print content anytime and anywhere. There are numerous approaches that have been proposed to address efficient and fast printing over the Internet using mobile devices. One such approach is a web printing service from Google, Inc., called Google Cloud Print™. Google and Google Cloud Print are trademarks of Google Inc., Mountain View, Calif., United States.

One drawback of the Google Cloud Print™ approach is that the printer must be defined to the cloud print service before printing can be done. Thus, users must associate printers with their corresponding Google accounts prior to using the web service. When a user prints a job using the Google Cloud Print service, the service sends the print job to the previously defined printer in a push manner. The user cannot simply walk up to a print device and request the printing of a document or image from his or her mobile device.

Accordingly, there is a need for mobile device users to have the ability to walk up to a web-enabled printer and use that printing device to retrieve a print job from a cloud print server in a pull manner without having the printer registered with the cloud service beforehand.

### SUMMARY

According to one example embodiment of the present disclosure, there is provided a method for retrieving one or more files from a cloud or a network for processing. The imaging device may receive a barcode from a mobile device, decode the barcode to obtain a job location, retrieve a print job from the job location and process the print job. The job location may be a uniform resource locator (URL) of the job.

In one aspect, the barcode may be provided by the mobile device by displaying the barcode in a communications interface of the mobile device. In another aspect of the first example embodiment, the barcode may be received by the imaging device by scanning the barcode displayed in the communications interface of the mobile device. In yet another aspect of the first example embodiment, the imaging device may retrieve the print job using a pull process wherein the imaging device retrieves the print job without intervention by the web print service. In another aspect of the first example embodiment, retrieving the print job by the imaging device may include connecting to a network.

In a second example embodiment, there is provided a method performed by a mobile device for retrieving a print job from a network. The method includes sending one or more files to a remote storage location via a web print service, receiving the storage location identifier identifying where the one or more files is stored, and encoding the storage location identifier into a barcode. The storage location identifier may be a URL or a network address of the one or more files and may be used in retrieving the one or more files for printing.

In one aspect of the second example embodiment, the method may further include sending the one or more files to a web print service. In another aspect of the second example embodiment, the web print service may render the one or more files into a printable format. In still another aspect of the second example embodiment, the one or more files may be stored by the web print service to the remote storage location, and the web print service may send the storage location or storage location identifier of the one or more files to the mobile device upon request by the mobile device. The storage location identifier may also be sent to the mobile device automatically upon storing of the one or more files. In yet another aspect of the embodiment, the barcode encoded with the storage location identifier of the one or more files may be displayed on a communications interface of the mobile device.

In a third example embodiment, there is provided a system for performing print job retrieval from the cloud that includes an imaging device, a web print service accessible by the print device and a mobile device. The mobile device may send one or more files to the web print service for storing, and the web print service may send the storage location identifier of the one or more files to the mobile device. The mobile device may encode the storage location identifier into a barcode and provide the barcode to the imaging device for scanning.

In one aspect of the third example embodiment, the imaging device may scan the barcode displayed in an interface of the mobile device. In another aspect, the imaging device may decode the barcode to obtain the storage location identifier of the one or more files in the network. In yet another aspect of the third embodiment, the imaging device may retrieve the one or more files using the storage locationidentifier. The imaging device may retrieve the one or more files in a pull process automatically or with user intervention. In yet another aspect the imaging device may print the one or more files onto a medium. Alternatively, the imaging device may also process the retrieved one or more files. In another aspect of the third example embodiment, the web print service may render the one or more files into a printable format.

Other embodiments, objects, features and advantages of the invention will become apparent to those skilled in the art from the detailed description, the accompanying drawings and the appended claims.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 is a schematic diagram of a data communication system.

FIG. 2 is one example flowchart of a method of storing a print job in the cloud and retrieving the storage location according to one example embodiment.

FIG. 3 is one example flowchart of a method of print job retrieval from the cloud as performed by an imaging device according to one example embodiment.

FIG. 4 illustrates an example implementation of displaying a barcode in an interface of the mobile device according to one example embodiment.

### DETAILED DESCRIPTION OF THE DRAWINGS

The following description and drawings illustrate embodiments sufficiently to enable those skilled in the art to practice the present disclosure. It is to be understood that the disclosure is not limited to the details of construction and the arrangement of components set forth in the following description or illustrated in the drawings. The disclosure is capable of other embodiments and of being practiced or of being carried out in various ways. For example, other embodiments may incorporate structural, chronological, electrical, process, and other changes. Examples merely typify possible variations. Individual components and functions are optional unless explicitly required, and the sequence of operations may vary. Portions and features of some embodiments may be included in or substituted for those of others. The scope of the application encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Further, the terms “a” and “an” herein do not denote a limitation of quantity but rather denote the presence of at least one of the referenced item.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block of the block diagrams, or combinations of blocks in the diagrams discussed in detail in the description below.

These computer program instructions may also be stored in a non-transitory computer-readable memory that may direct a computer or other programmable data processing apparatus to function in a particular manner, such that the instructions stored in the computer-readable memory produce an article of manufacture including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the diagrams support combinations of means for performing the specified functions, combinations of steps for performing the specified functions and program instruction means for performing the specified functions. It will also be understood that each block of the block diagrams, and combinations of blocks in the block diagrams, may be implemented by special purpose hardware-based computer systems that perform the specified functions, actions or steps, or combinations of special purpose hardware and computer instructions.

Disclosed are methods and a system for retrieving a print job from the cloud or a web print service. According to one example embodiment of the present disclosure, a user of a mobile device may send one or more files for printing to a cloud via a web print service. The one or more files may be stored by the web print service in a storage location remote from both the mobile device and an imaging device for subsequent retrieval of the one or more files for printing. Such storage location may be either a storage server or the same server on which the web print service is running. The web print service may send the storage location identifier of the one or more files to the mobile device. The storage location identifier may then be encoded by the mobile device into a barcode and displayed on a user interface of the mobile device. The imaging device may scan the barcode displayed on the user interface of the mobile device in order to obtain the storage location identifier encoded in the barcode. In one alternative embodiment, the storage location identifier may be encoded by the mobile device into a text string displayed in a font format recognizable by the imaging device. Upon obtaining the storage location identifier, the imaging device may retrieve and print the one or more files.

For purposes of the present disclosure, it will be appreciated that the one or more files may consist of documents, photos or any other file that may be used to generate or produce a printed output on a media. The process for printing the one or more files may require that the one or more of these files be processed and/or reassembled into a format that resembles that which is displayed on an interface when the one or more files are accessed. If the one or more files displayed on or retrieved by the imaging device are not in a format that the imaging device recognizes or is capable of printing, a transform or conversion process may be performed on the one or more files in order to convert the one or more files into a format recognizable by the imaging device, i.e., a printable format. Printable formats may include, but are not limited to, PCL, PostScript, .jpeg and PDF formats.

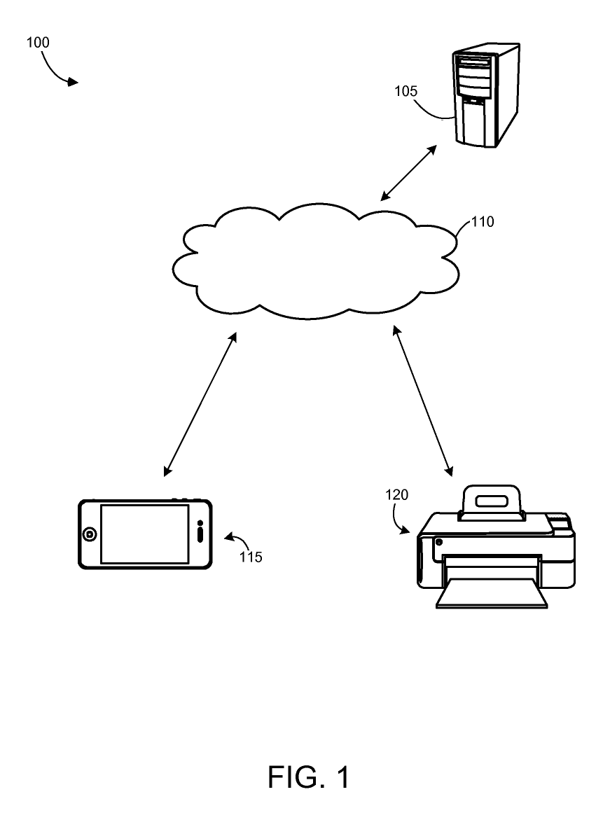

Referring to FIG. 1, there is shown a diagram of a system 100, according to one example embodiment. The system 100 is a data communication system comprising a network 110 that interconnects a web print service 105, a mobile device 115 and an imaging device 120. Imaging device 120 may be web-enabled and may be capable of communicating directly with web print service 105. For example, imaging device 120 may be connected to web print service 105 via a communication link, which may be established by a wired or wireless connection such as, for example, an Ethernet connection.

Web print service 105 may be a software application running on a server and may be connected to a large scale communications network such as the Internet. In some alternative embodiments, the large scale communications network may be a proprietary communications network, such as those used by governments or large companies. Web print service 105 may be capable of receiving one or more files from mobile device 115 and may also store and, if necessary, render such files into a printable format. Web print service 105 may be accessed by imaging device 120 to retrieve the one or more files that have been sent to web print service 105 by mobile device 115. Web print service 105 may store the one or more files in a remote storage location such as, for example, a database server. The storage location identifier may be a uniform resource locator (URL) pointing to the storage location of the one or more files which may then be used by imaging device 120 to access, retrieve, and/or subsequently print such files. The storage location identifier may also be a network address indicating where the one or more files are stored. In some alternative embodiments, each of the one or more files has a separate URL. It will be appreciated by one of ordinary skill in the art that there may be other forms and formats of the storage location identifier that may be used to access and retrieve the one or more files from the remote storage location. Web print service 105 may communicate with imaging device 120 via one or more appropriate communications links, as will be understood by those of ordinary skill in the art. Web print service 105 may communicate with mobile device 115 via network 110 using one or more appropriate communication links, as will be explained in greater detail herein.

Imaging device 120 may be any device capable of printing or producing a hard copy data file or document stored in electronic form, such as a laser, inkjet or dot matrix printer or multi-function printing device that has the capability of performing other functions, such a faxing, e-mailing, scanning and/or copying, in addition to printing.

In one aspect, imaging device 120 may include a processor (not shown) in communication with a user interface (not shown), a memory (not shown), and a scanning subsystem (not shown). The user interface may be a graphical user interface, a monitor, a series of buttons, a touch-sensitive display panel, a text interface such as a 2-line display, a voice-activated interface or the like. In one aspect, the user interface may serve as an operating panel for imaging device 120. It is also within the scope of this aspect to utilize a computer (not shown), such as personal computer, having a monitor as the user interface. Those skilled in the art will appreciate that imaging device 120 may include various additional components, such as a facsimile, scanner and/or card reader. Imaging device 120 may also include one or more appropriate software applications configured to receive print data or one or more files from web print service 105 and to output printed pages through a print engine (not shown) of imaging device 120.

Imaging device 120 may include a communications interface and a control unit. Additionally, the control unit of imaging device 120 may include a barcode scanner application that may read a barcode and decode data that is encoded into the barcode. It will be understood that the barcode scanner application may be a software application that is stored in memory associated with the control unit and executed by the control unit in accordance with programmed logic associated with the software application. In some alternative embodiments, the barcode scanner application may be implemented in the firmware of imaging device 120. In yet other alternative embodiments, the barcode scanner application may be implemented as a combination of firmware and software.

A mobile communications link, such as a cell phone data link or Wi-Fi link, may allow mobile device 115 to communicate with web print service 105 via network 110. As shown in FIG. 1, mobile device 115 may be communicatively coupled to web print service 105 via the mobile communications link. Mobile device 115 may be any computing device that is portable, handheld or pocket-sized such as, for example, a mobile telephone (e.g., a cell phone), a smart phone, a handheld computer, a personal digital assistant (PDA), a notebook computer, a tablet computer, or any other remote computing device, such as a special-purpose remote computing device like an e-book reader. Additionally, mobile device 115 may include at least one control unit such as, for example, a processor (not shown), that controls the operation of mobile device 115.

Web print service 105 may receive one or more files from mobile device 115 via the mobile communications link. Mobile device 115 may upload the one or more files to web print service 105 for rendering into a printable format for printing and/or for storing in web print service 105 or in a storage location remote from either or both mobile device 115 and web print service 105. Web print service 105 may have an appropriate software application program that is capable of directing the translation of the one or more files to a format recognized by imaging device 120. Once the files or data has been translated into an appropriate format for printing, it may be referred to as a print job. Web print service 105 may transfer the one or more files to a remote storage location, such as, for example, a database server, where the one or more files may be obtained by imaging device 120 for printing. It will be appreciated by one of ordinary skill in the art that in some example embodiments, mobile device 115 may also render the one or more files into a printable format before uploading the one or more files to web print service 105.

Network 110 may be any Internet Protocol (IP) based computer network capable of communicating data and other information between mobile device 115, imaging device 120, and web print service 105. In some example embodiments, network 110 may also communicate with a remote storage location, such as a database server (not shown). Network 110 may comprise a Local Area Network (LAN) or a wide area network (WAN) (e.g., Internet), and may be a public or private network. Network 110 may use any communication medium, such as cable, optical fiber, radio carriers, etc., or any combination thereof, to communicate with web print service 105, imaging device 120 and mobile device 115.

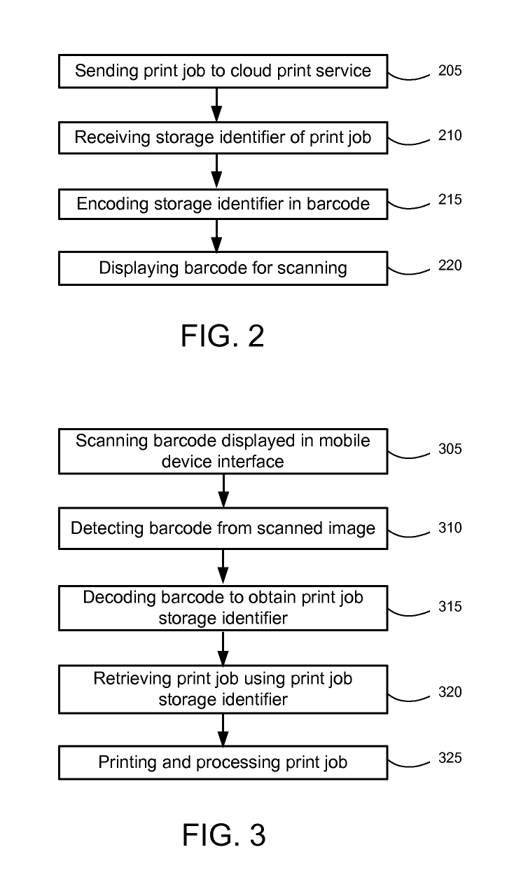

FIG. 2 shows an example method of storing a print job in the cloud and retrieving the storage location identifier. At block 205, mobile device 115 may send one or more files to web print service 105. As set forth above, mobile device 115 may send the one or more files via the mobile communications link, as will be understood by those of ordinary skill in the art. The mobile communications link may be established by a direct cable connection, by a wireless connection, and/or by a network connection such as, for example, an Ethernet local area network (LAN). Web print service 105 may then store the one or more files in a remote storage location accessible to network 110.

At block 210, mobile device 115 may receive the storage location identifier for the one or more files. The storage location identifier may be any format or type of location identifier that may be used to access and retrieve the one or more files. For example, the storage location identifier may be a uniform resource locator (URL) pointing to the storage location of the one or more files. In one alternative example embodiment, the storage location identifier may be network address. The storage location identifier may be sent by web print service 105 to mobile device 115 upon request in order for a user of mobile device 115 to retrieve the one or more files for printing by imaging device 120. In some alternative example embodiments, the storage location identifier may be sent to mobile device 115 automatically upon web print service 105 storing the one or more files in the storage location.

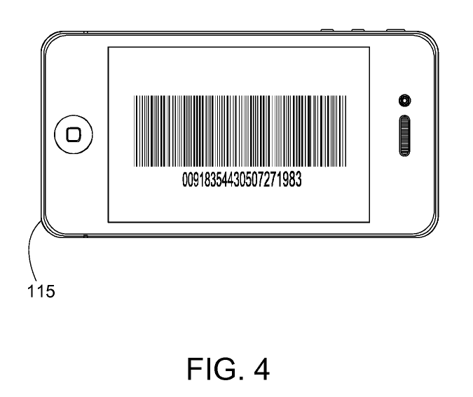

At block 215, mobile device 115 may encode the storage location identifier in a barcode. The barcode may be a one-dimensional or linear barcode as shown in FIG. 4 or a high-density two-dimensional barcode such as, but not limited to, a PDF417, DataMatrix and QRCode barcode. The encoding of the storage location identifier into a barcode may be performed by an associated application that may be installed in mobile device 115. In some alternative embodiments, the encoding of the storage location identifier into a barcode may also be performed by web print service 105 and sent to mobile device 115 as an image.

At block 220, mobile device 115 may display the barcode in a user interface of mobile device 115, as shown in FIG. 4. Mobile device 115 may display the barcode as an image using a barcode display application or an image viewer application installed in mobile device 115. It will be understood by one of ordinary skill in the art that there may be other methods of displaying the barcode in the user interface of mobile device 115 given the benefit of this disclosure.

FIG. 3 shows one example method of print job retrieval from the cloud as performed by imaging device 120. At block 305, imaging device 120 may scan the barcode displayed in the user interface of mobile device 115. Imaging device 120 may include a scanning subsystem configured to scan a barcode or an image of a barcode in the user interface of mobile device 115. For example, a user who wishes to retrieve the one or more files from web print service 105 for printing may configure the scanning subsystem of imaging device 120 to scan the barcode displayed in the user interface of mobile device 115.

In one example embodiment, an application running on imaging device 120 may monitor imaging device 120 for a user input, such as a pressing of a designated key on a keypad, a touching of the user interface or display screen in a preset location, an inputting of a designated sequence using an input mechanism or a making of a user selection on a user interface of imaging device 120, to initiate a scan. When such user input is detected, the application may initiate a workflow that captures a scanned image of mobile device 115 or at least the user interface of mobile device 115 using the scanning subsystem of imaging device 120. In some alternative example embodiments, the scanned image of mobile device 115 may be automatically captured upon the detection of an image to be scanned.

At block 310, the captured image may then be automatically searched to detect whether a barcode is present. In some other example embodiments, a user may designate where the barcode is present such as by, for example, drawing a box around or highlighting the portion of the captured image displayed on the user interface of imaging device 120 or a monitor attached to imaging device 120 to indicate where the barcode is located. As will be appreciated by those of ordinary skill in the art, other methods of designating the location of the barcode may be used.

Once the barcode is located, imaging device 120 may decode the scanned barcode to obtain the storage location identifier of the one or more files to be retrieved for printing (block 315). Imaging device 120 may have the appropriate technology or communication means to decode barcodes. Such technology or communication means may be integrated into imaging device 120 or may be external components attached to imaging device 120 via a communications port, such as a USB port.

Imaging device 120 may include the appropriate firmware, software and/or hardware to interpret the barcode. For example, imaging device 120 may be installed with a known barcode reader or interpreter application configured to translate and/or interpret the information decoded in the barcode. In another example embodiment, the barcode application may be a customized barcode application which may monitor imaging device 120 for a user action, such as a button pressed or screen touched, and when detected, may initiate a workflow to control imaging device 120 to retrieve and print the one or more files. In still another example embodiment, the barcode application may be just a portion of an application specifically designed to control imaging device 120 and automatically retrieve the one or more files from the remote storage location for printing.

In one example embodiment, imaging device 120 may automatically recognize the barcode scanned as being encoded with the storage location identifier of the one or more files to be printed. In other example embodiments, the recognition of the storage location identifier may occur only after a user provides an indication that the barcode represents the storage location identifier. For example, a user may make a particular selection (e.g., pressing a designated key on a keypad, touching user interface or display screen in a preset location, inputting a designated sequence using an input mechanism of imaging device 120, etc.) in order to differentiate or distinguish to imaging device 120 that the barcode to be scanned is encoded with the storage location identifier of the one or more files and not simply a print job. In one aspect, such selection may also cause imaging device 120 to initiate an appropriate application or component to decode the barcode to obtain the storage location identifier.

The storage location identifier may be extracted from the barcode, and imaging device 120 may retrieve the one or more files using the storage location identifier for subsequent printing and/or processing (block 320). The retrieval may be automatically executed by imaging device 120 or may require user intervention. In some alternative example embodiments, the retrieval of the one or more files may be performed using a pull process wherein imaging device 120 retrieves the one or more files.

Retrieval of the one or more files may be performed by downloading the one or more files from the remote storage location where they are stored. Once downloaded, the one or more files may be stored and/or rendered into a printable format recognizable to imaging device 120. In some example embodiments, the one or more files may be rendered into a printable format by web print service 105 or the mobile device prior to the retrieval of the one or more files by imaging device 120.

At block 325, imaging device 120 may print or output a hardcopy of the downloaded files. In some example embodiments, in lieu of or in addition to printing, the downloaded files may be processed by imaging device 120. Processing may include e-mailing the one or more files. Processing may also include storing the one or more files in the memory of imaging device 120. In addition to printing, the user may also wish to e-mail the one or more files to an e-mail address or store the one or more files in another remote storage location for future use. It will be understood by one of ordinary skill in the art that imaging device 120 may perform other processes on the one or more files given the benefit of this disclosure.

The actions described and shown in the example flowcharts may be carried out or performed in any suitable order. One of ordinary skill in the art will also recognize that not all of the actions described in FIGS. 2 and 3 need to be performed and/or additional actions may be performed.

Many modifications and other embodiments will come to mind to one skilled in the art to which this disclosure pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method, comprising:
receiving a barcode from a mobile device;
decoding the barcode to obtain a job location;
retrieving a print job from the job location, and
processing the print job.

2. The method of claim 1, wherein the job location is a uniform resource locator (URL) of the print job.

3. The method of claim 1, wherein the receiving the barcode includes a display of the barcode in a communications interface of the mobile device.

4. The method of claim 1, wherein the receiving the barcode includes scanning the barcode displayed in a communications interface of the mobile device.

5. The method of claim 1, wherein the retrieving the job is initiated by the imaging device automatically without user intervention.

6. The method of claim 1, wherein the retrieving the job comprises connecting to a network.

7. The method of claim 1, wherein the processing the print job comprises printing the retrieved print job.

8. A method, comprising:
sending a file to a remote storage location;
receiving a storage location identifier identifying where the file is stored; and
encoding the storage location identifier into a barcode.

9. The method of claim 8, further comprising sending the file to a web print service.

10. The method of claim 8, wherein the file is rendered into a printable format by a web print service.

11. The method of claim 8, wherein the storage location identifier is a uniform resource locator (URL).

12. The method of claim 8, wherein the storage location identifier is a network address.

13. The method of claim 8, further comprising displaying the barcode on a communications interface of the mobile device.

14. A system, comprising:
an imaging device;
a web print service accessible by the print device; and
a mobile device,
wherein the mobile device sends a file to the web print service for storing, wherein the web print service sends a location of the stored file to the mobile device, wherein the mobile device encodes the location into a barcode, and wherein the imaging device scans the barcode to retrieve the location.

15. The system of claim 14, wherein the imaging device scans the barcode displayed in an interface of the mobile device.

16. The system of claim 14, wherein the imaging device decodes the barcode to obtain the location of the stored file.

17. The system of claim 14, wherein the imaging device retrieves the stored file from the location.

18. The system of claim 14, wherein the imaging device processes the stored file.

19. The system of claim 14, wherein the web print service renders the file into a printable format.

20. The system of claim 14, wherein the location is a uniform resource locator (URL) of the file.
